(19) United States
(12) Patent Application Publication
(10) Pub. No.: US 2006/0179710 A1
(43) Pub. Date: Aug. 17, 2006

(54) Decorative device, in particular for urban development and landscape arrangement

(75) Inventor: Pascal Peleszezak, Feyzin (FR)

Correspondence Address: OLIFF & BERRIDGE, PLC, P.O. BOX 19928, ALEXANDRIA, VA, 22320, US

(73) Assignee: Canevaflor, Lyon (FR)

(21) Appl. No.: 10/517,278

(22) PCT Filed: Jun. 11, 2003
(86) PCT No.: PCT/FR03/01743

§ 371 Date: Mar. 29, 2006

(30) Foreign Application Priority Data
Jun. 12, 2002 (FR) 0207221

(51) Int. Cl. A01G 31/00

(52) U.S. Cl. 47/59 S

(57) ABSTRACT

The invention concerns a decorative device consisting of a support layer having some flexibility, on one surface of which are set and fixed, along predefined zones, plant or mineral materials of selected colours, which a produce a predetermined pattern. Said materials can be set using a moulding template, provided with orifices corresponding to said zones. Some raised parts left free on the support layer, advantageously surround the various coloured areas. The inventive device is useful for urban and landscape arrangement, as well as for decoration for special events.

The present invention relates, in general terms, to the field of decorations which can be produced from vegetable or mineral materials. It refers more particularly, but not exclusively, to a decorative device which can be produced from such materials and which contributes to urban development and landscape arrangement.

Even more particularly, the subject of this invention is a technical device intended for the permanent or temporary decoration of lawns, clumps of trees, grassy areas and slopes, this device being capable of assuming any shapes and dimensions and of being installed on any type of ground, whether this be horizontal, inclined or voluminous.

The decoration of “green spaces” is conventionally carried out by the planting of flowers. These plantings have to be prepared and executed by specialized personnel, and, by their very nature, they have a highly seasonal character.

The present invention is aimed at overcoming these disadvantages by providing a decorative device which is easy to implement and which can replace flower beds, especially in winter time. This device also makes it possible to produce an easily interchangeable “special event” decoration.

For this purpose, the subject of the invention is essentially a decorative device, in particular for urban development and landscape arrangement, which consists essentially of a supporting sheet having some flexibility, on at least one face of which are arranged and secured, according to predefined zones, vegetable or mineral materials of selected colors which produce a predefined design or decoration.

The supporting sheet advantageously consists of a layer of textile material, of fibrous material or of synthetic material waste. This is, for example, a textile material of the cotton, flax or felt type, having the property of being permeable to rainwater or trickling water.

As regards the colored materials deposited and secured on the supporting sheet, these may be particularly:
in the case of vegetable materials: wood chips or bark fragments;
in the case of mineral materials: grains of sand or gravel or else glass balls.

Advantageously, the supporting sheet comprises parts in relief which correspond to the predefined contours of the various zones in which said vegetable or mineral materials are deposited and secured, and which thus make it possible to delimit these zones clearly, at the same time forming kinds of “molds” intended to be filled with the vegetable or mineral materials.

These vegetable or mineral materials may be painted or may receive a special surface treatment, making them, for example, fluorescent. If granular materials or materials in the form of chips are concerned, these are adhesively bonded to the upper face of the supporting sheet. Preferably, a glue or a varnish is also applied to the outside of these vegetable or mineral materials, in order to bind these materials appropriately and to protect them.

The subject of the invention is also an industrial process developed specially for the manufacture of the decorative device defined above.

This process involves essentially cutting out a supporting sheet according to a predefined contour, placing onto the cut-out supporting sheet a molding template provided with orifices corresponding to the predefined zones which are to receive vegetable or mineral materials, coating with glue the upper face of the supporting sheet in the various zones thus delimited, and filling these zones by depositing said vegetable or mineral materials therein.

The molding template can form a “lost mold” which remains in place on the supporting sheet after the securing of the vegetable or mineral materials, the said template, in particular, being adhesively bonded to this supporting sheet. Preferably, however, within the framework of “series” production, the molding template is not secured permanently to the supporting sheet and may therefore be removed after the vegetable or mineral materials have been deposited and secured on the supporting sheet; this molding template thus becomes reusable for the manufacture of a new decorative device identical to the preceding one.

Advantageously, especially with regard to a reusable molding template, the process also involves, after the placing of the molding template onto the supporting sheet, the installation of frames, corresponding to the contours of the various zones, in the orifices of this molding template, the vegetable or mineral materials being deposited inside these frames which themselves remain in place on the supporting sheet and thus form the parts in relief (mentioned above) which delimit the various zones.

Overall, the decorative device which is the subject of the invention and with which this specific manufacturing process is associated, possesses the following advantages:
The device forms a decoration which is installed easily and quickly on any ground, the flexibility of the supporting sheet allowing it to be adapted to the irregularities of the ground.
By virtue of the flexibility of its supporting sheet and of its production from divided materials (chips or grains), the device can be folded or wound up for its storage and transport with a reduced bulk.
In particular, where use in winter is concerned, the decorative device can be manufactured or prepared at a sheltered location and then be easily and quickly installed and secured to the ground at the selected site.
This device makes it possible to produce decorations of any shapes and of any dimensions, if appropriate by juxtaposing two or more elementary devices which complete one another to form a final decoration having large dimensions.
The decorative device which is the subject of the invention is relatively resistant to atmospheric influences (wind, rain), while at the same time being capable of being produced from biodegradable materials which make it “ecological” and eliminate any need for recycling.
The parts in relief above the supporting sheet form borders for the various colored zones, thus ensuring the sharpness of the contours of these zones.
In order to increase the visual impact of this decorative device, it is possible to make it fluorescent, at least in some zones, or to incorporate in it a lighting system, in particular by means of optical fibers.
This decorative device may also have a recreational and educational appearance, being produced in smaller dimensions and being designed as a children's game involving manual activities.
By virtue of its specific manufacturing process, the decorative device can be produced on an industrial scale, accurately and with a high degree of reproducibility.
The creation and manufacture of this decorative device can be carried out with the aid of modern information technology methods: computer-assisted creation (CAC), computer-assisted design (CAD), cut-out on a computer-controlled automatic machine.
Finally, this decorative device remains especially economical both in terms of its composition and in terms of its manufacturing process: on the one hand, it can be produced from materials of very low costs, such as textile or plastic waste, wood waste or sand, and, on the other hand, its manufacture involves only a low outlay, especially with regard to the use of a recoverable and reusable molding template. It will also be noted that the manufacture of the device can be optimized, in terms of the quantity of material used, by the suitable positioning of the various elements to be cut out from a basic sheet, for example by cutting out the smallest elements from the material surrounding by the largest elements.

The invention will be understood more clearly from the following description, with reference to the accompanying diagrammatic drawing showing an embodiment of this decorative device by way of example and illustrating the process for the manufacture of this decorative device:

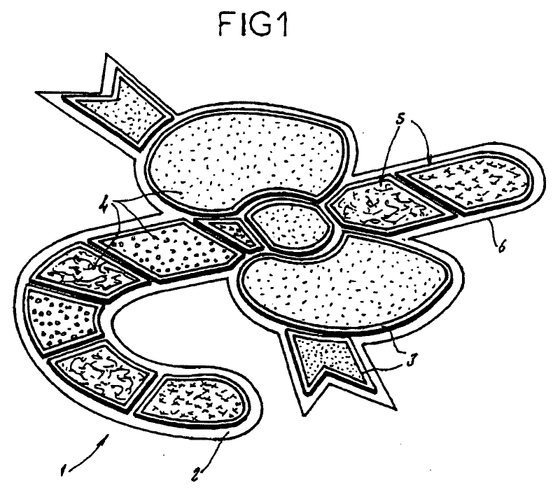

FIG. 1 is an overall perspective view of a decorative device according to the present invention;

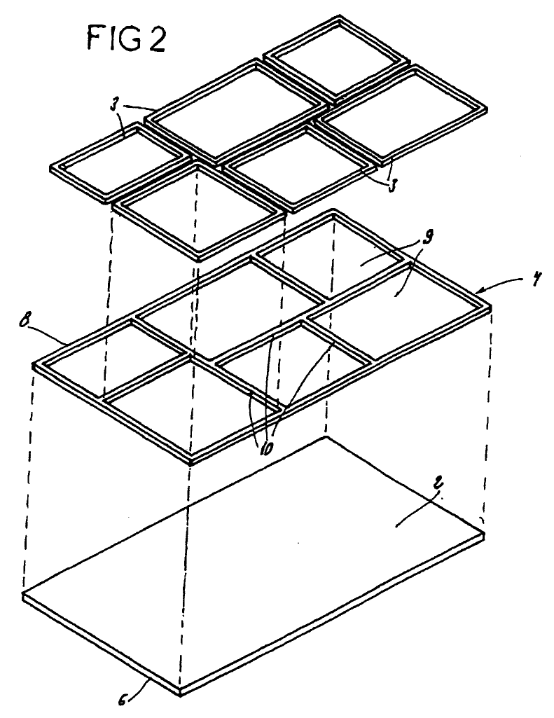

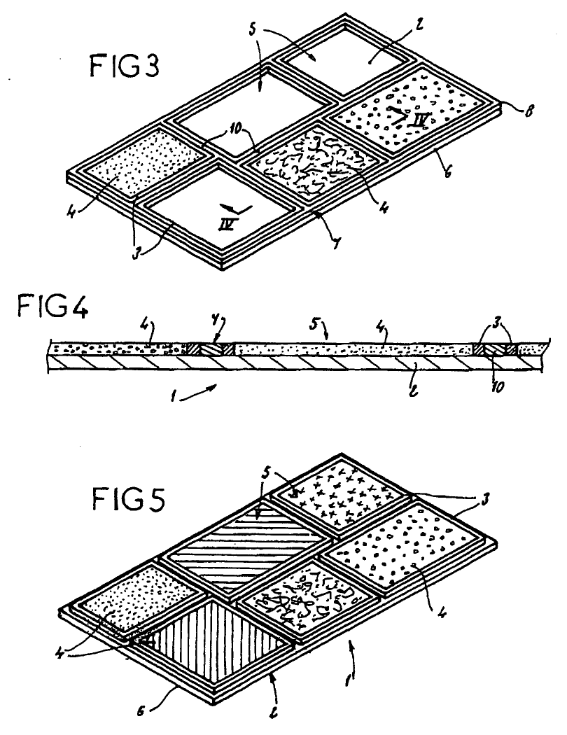

FIGS. 2 and 3 are highly diagrammatic perspective views illustrating successive steps in the manufacture of such a decorative device;

FIG. 4 is a partial section through the diagram of FIG. 3 along the line IV-IV;

FIG. 5 is a final view, similar to the preceding diagrams, showing the termination of the process, that is to say the decorative device in the definitive state.

The decorative device, shown in FIG. 1 and designated as a whole by the reference 1, is composed, in its definitive state, of a supporting sheet 2, of parts in relief 3 in the form of frames, carried by the upper face of the supporting sheet 2, and of vegetable or mineral materials 4 deposited and secured on the upper face of the supporting sheet 2 in the various zones 5 delimited by the parts in relief 3.

The supporting sheet 2 consists of a layer of textile material, of fibrous material or of plastic waste, which is cut out according to a predefined contour 6.

The parts in relief 3, in the form of frames, can be produced from the same material as the supporting sheet 2. These parts in relief 3 are attached to the supporting sheet 2 and, in particular, adhesively bonded to this supporting sheet 2.

The various parts in relief 3 are virtually adjacent to one another; they correspond to the various colored areas of the design or decoration to be produced.

The vegetable or mineral materials 4 are, for example, painted wood chips or colored grains of sand. These materials fill the various zones 5 delimited by the parts in relief 3. Such vegetable or mineral materials 4, having the color corresponding to the predefined design or decoration, are deposited and secured in each zone 5 in as uniform a layer as possible.

By means of suitable glues and/or binders, the vegetable or mineral materials 4 are secured to the upper face of the supporting sheet 2 and also bound to one another to form a coherent layer. A varnish covers these vegetable or mineral materials 4 on the outside. The whole of the decorative device 1 thus formed possesses some flexibility which allows it to be adapted to the irregularities of the ground on which it is placed, and which also makes it possible for it to be wound up or folded for its transport.

FIGS. 2 to 5 illustrate the process for the manufacture of the decorative device 1 described above.

Initially, the supporting sheet 2 is cut out from the selected material according to the predefined contour 6 (see the bottom of FIG. 2).

A molding template 7 is also available, which possesses on the outside the same contour 8 as that 6 of the supporting sheet 2 and which is provided over its extent with a certain number of orifices 9 separated by more or less narrow strips of material 10. The various orifices 9 of the molding template 7 correspond substantially to the future colored areas of the device 1.

Frames intended to form the future parts in relief 3 of the device 1 are likewise available. Each frame (also designated here by the reference 3) corresponds with its outer contour to one of the orifices 9 of the molding template 7.

With all these elements being available, the molding template 7 is placed onto the upper face of the supporting sheet 2, and the various frames 3 are also installed on this supporting sheet 2 in the corresponding orifices 9 of the molding template 7—see FIGS. 3 and 4.

Subsequently, the upper face of the supporting sheet 2 is coated with glue in its parts which remain uncovered, and the vegetable or mineral materials 4 are fed into the zones 5 delimited by the various frames 3, each zone 5 receiving a vegetable or mineral material 4 of the appropriate color which has been predefined—see FIG. 3.

In detail, in this phase of the process, a first partial layer of vegetable or mineral material 4 may be scattered onto the glue-coated upper face of the supporting sheet 2, and then the surface of the first partial layer may be recoated with glue, before a second partial layer and, if appropriate, additional partial layers are deposited. The glue-coating operations are carried out with the aid of a paint brush or a sprayer. The surface of the last partial layer is leveled, while at the same time all of the laid layers of vegetable or mineral material 4 are packed together. Finally, an outer layer of glue or of specific varnish is applied to the outermost layer of vegetable or mineral material 4.

The molding template 7 is then removed, whereas the frames 3 remain in place on the supporting sheet 2, so that the decorative device has its final appearance, with its various colored areas being delimited by the frames 3 left in place, which form parts in relief surrounding the various colored areas—see FIG. 5.

In a variant of the process, the molding template 7 is also left in place on the supporting sheet 2 in the manner of a “lost mold”.

There would be no departure from the scope of the invention, as defined in the accompanying claims:
if the device were produced from any suitable materials;
if the device were given any outer dimensions and shapes;
if the device were produced with any types of designs, whether figurative or not, and of greater or lesser complexity, the design possibly being partially or completely a brief text;
if all accessories, such as means for anchoring to the ground, lighting system, etc., were provided on the device;
if this decorative device were obtained by any process and any suitable techniques;
if the device which is the subject of the invention were intended for all kinds of use: urban development and landscape arrangement, in particular of lawns, clumps of trees, slopes or traffic circles, but also “special event” decoration;
if this decorative device were used, if appropriate, in a suspended position or as a vertical panel, and not placed flat on the ground;
particularly with regard to this suspended use or use as a vertical panel, if the colored vegetable or mineral materials were deposited onto both faces of the supporting sheet.

1. A decorative device, in particular for urban development and landscape arrangement, characterized in that it consists of a supporting sheet having some flexibility, on at least one face of which are deposited and secured, according to predefined zones, vegetable or mineral materials of selected colors, which produce a predetefined design or decoration.

2. The decorative device as claimed in claim 1, characterized in that the supporting sheet consists of a layer of textile material, of fibrous material or of synthetic material waste.

3. The decorative device as claimed in claim 2, characterized in that the supporting sheet consists of a textile material of the cotton, flax or felt type.

4. The decorative device as claimed in claim 1, characterized in that the colored materials deposited and secured on the supporting sheet are vegetable materials, such as wood chips or bark fragments.

5. The decorative device as claimed claim 1, characterized in that the colored materials deposited and secured to the supporting sheet are mineral materials, such as grains of sand or gravel or else glass balls.

6. The decorative device as claimed in claim 1, characterized in that the supporting sheet comprises parts in relief which correspond to the predefined contours of the various zones in which said vegetable or mineral materials are deposited and secured.

7. The decorative device as claimed in claim 1, characterized in that said vegetable or mineral materials are painted or receive a special surface treatment, making them, for example, fluorescent.

8. The decorative device as claimed in claim 1, characterized in that, with regard to granular materials or materials in the form of chips, these are adhesively bonded to the upper face of the supporting sheet.

9. The decorative device as claimed in claim 1, characterized in that the varnish is applied to the outside of said vegetable or mineral materials.

10. The decorative device as claimed in claim 1, characterized in that it has incorporated in it a lighting system, in particular by means of optical fibers.

11. The decorative device as claimed in claim 1, characterized in that it results from the juxtaposition of two or more elementary decorative devices, to form a final decoration having large dimensions.

12. The decorative device as claimed in claim 1, characterized in that it is produced with smaller dimensions and is designed as a children's game involving manual activities.

13. A process for the manufacture of the decorative device as claimed in claim 1, characterized in that it involves cutting out a supporting sheet according to a predefined contour, placing onto the cut-out supporting sheet molding template provided with orifices corresponding to the predefined zones which are to receive vegetable or mineral materials, coating with glue the upper face of the supporting sheet in the various zones thus delimited, and filling these zones by depositing said vegetable or mineral materials therein.

14. The method as claimed in claim 13, characterized in that the molding template forms a “lost mold” which remains in place on the supporting sheet after the securing of the vegetable or mineral materials, said template, in particular, being adhesively bonded to this supporting sheet.

15. The method as claimed in claim 13, characterized in that the molding template is not secured permanently to the supporting sheet and is therefore removed after the vegetable or mineral materials have been deposited and secured on the supporting sheet, this molding template thus becoming reusable for the manufacture of a new decorative device.

16. The method as claimed in claim 15, characterized in that it also involves, after the placing of the molding template onto the supporting sheet, the installation of frames, corresponding to the contours of the various zones, in the orifices of this molding template, the vegetable or mineral materials being deposited inside these frames which themselves remain in place on the supporting sheet and thus form the parts in relief which delimit the various zones.
